(19) United States
(12) Patent Application Publication
(10) Pub. No.: US 2008/0182120 A1
(43) Pub. Date: Jul. 31, 2008

(54) BOND PAD FOR SEMICONDUCTOR DEVICE

(76) Inventors: Lan Chu Tan, Klang (MY); Heng Keong Yip, Selangor (MY); Cheng Choi Yong, Kuala Lumpur (MY)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/627,980

(22) Filed: Jan. 28, 2007

(51) Int. Cl. B32B 3/00

(52) U.S. Cl. 428/603

(57) ABSTRACT

A bond pad (12, 14) for a semiconductor device (10) is generally L-shaped and includes a first portion (20, 24) for receiving a bond wire, and a second portion (22, 26) extending substantially perpendicularly from the first portion (20, 24). The bond pad (12) may include a third portion (16, 18) adjacent to the first portion (20). The third portion (16, 18) may be an embedded power pad (16) or an embedded ground pad (18).

### BACKGROUND OF THE INVENTION

The present invention relates to semiconductor devices and more particularly to a bond pad for a semiconductor device.

Bond pads are formed on a semiconductor device to provide means for transferring electrical signals and power to and from circuitry of the semiconductor device via probes, bond wires, conductive bumps, etc. Bond pads are typically arranged in a single row, multiple rows along the perimeter of the semiconductor device, or in an array format. To accommodate increases in semiconductor device densities and input/output (I/O) requirements, semiconductor device manufacturers are looking to reduce the spacing between bond pad, known as pitch. However, bond pad pitch reduction poses a number of assembly problems and limitations. For example, because spacing between bond wires is reduced when bond pad pitch is reduced, there is an increased risk of wire shorting arising from wire looping and wire trajectory variations and from wire sweep during mold encapsulation. Thus, a need exists for a bond pad that is compatible with fine pitch applications and that facilitates the subsequent assembly process.

### BRIEF DESCRIPTION OF THE DRAWINGS

The following detailed description of preferred embodiments of the invention will be better understood when read in conjunction with the appended drawings. The present invention is illustrated by way of example and is not limited by the accompanying figures, in which like references indicate similar elements. It is to be understood that the drawings are not to scale and have been simplified for ease of understanding the invention.

FIG. 1 is an enlarged top plan view of a semiconductor device in accordance with an embodiment of the present invention;

FIG. 2 is an enlarged top plan view of a pair of bond pads including embedded power and ground pads on the semiconductor device of FIG. 1; and

FIG. 3 is an enlarged cross-sectional view of a bond pad in accordance with one embodiment of the present invention.

### DETAILED DESCRIPTION OF THE INVENTION

The detailed description set forth below in connection with the appended drawings is intended as a description of the presently preferred embodiments of the invention, and is not intended to represent the only form in which the present invention may be practiced. It is to be understood that the same or equivalent functions may be accomplished by different embodiments that are intended to be encompassed within the spirit and scope of the invention. In the drawings, like numerals are used to indicate like elements throughout.

The present invention provides a bond pad for a semiconductor device. The bond pad includes a first portion for receiving a bond wire, and a second portion extending substantially perpendicularly from the first portion.

The present invention also provides a pair of bond pads for a semiconductor device. The pair of bond pads includes a first substantially L-shaped bond pad including a first portion for receiving a bond wire and a second portion extending substantially perpendicularly from the first portion for receiving a probe, and a second substantially L-shaped bond pad including a first portion for receiving a bond wire and a second portion extending substantially perpendicularly from the first portion for receiving a probe. The first and second bond pads are nested one with the other such that the second portions of the first and second bond pads are adjacent to each other and the first portions of the first and second bond pads are spaced from each other.

The present invention further provides a semiconductor device including a plurality of first substantially L-shaped bond pads on a surface of the semiconductor device. The first bond pads include first portions for receiving respective bond wires and second portions for receiving a probe. The second portions extend substantially perpendicularly from respective ones of the first portions.

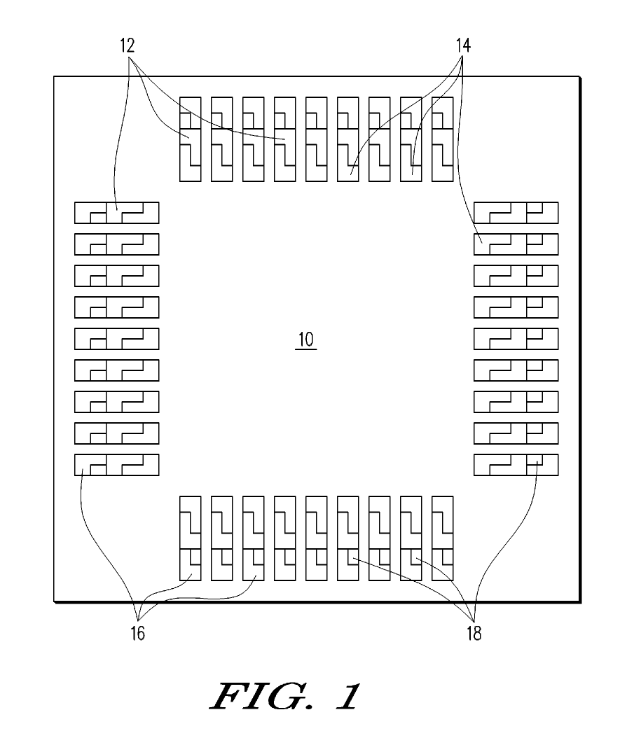

Referring now to FIG. 1, a semiconductor device 10 having first bond pads 12, second bond pads 14, embedded power pads 16 and embedded ground pads 18 on a surface thereof is shown. In the embodiment shown in FIG. 1, the first bond pads 12, the second bond pads 14, the embedded power pads 16 and the embedded ground pads 18 are arranged around a periphery of the semiconductor device 10. It will be understood by those of skill in the art that the arrangement could be otherwise, such as in an array over a central surface of the device 10. The first bond pads 12 are nested with respective ones of the second bond pads 14. The embedded power and ground pads 16 and 18 are adjacent to respective ones of the first bond pads 12. That is, in the embodiment shown in FIG. 1, the embedded power and ground pads 16 and 18 are proximate to the outer edge of the device 10. However, in an alternative embodiment, the power and ground pads could be proximate to a central area of the device 10 (i.e., adjacent to respective ones of the second bond pads 14). The embedded power pads 16 are nested with respective ones of the embedded ground pads 18.

The semiconductor device 10 may be a processor, such as a digital signal processor (DSP), a special function circuit, such as a memory address generator, or a circuit that performs any other type of function. The semiconductor device 10 is not limited to a particular technology such as CMOS, or derived from any particular wafer technology. Further, the present invention can accommodate devices of various sizes, as will be understood by those of skill in the art. A typical example is a memory device having a size of about 15 millimeters (mm) by 15 mm. The semiconductor device 10 is formed in a known manner using conventional semiconductor device fabrication processes. Accordingly, further description of the manufacture of the semiconductor device 10 is not required for a complete understanding of the present invention.

Referring now to FIG. 2, an enlarged top plan view of a pair of bond pads on the semiconductor device 10 of FIG. 1 is shown. The pair of bond pads includes the first and second bond pads 12 and 14 shown in FIG. 1. Also included are the embedded power and ground pads 16 and 18. The first bond pad 12 is substantially L-shaped and includes a first portion 20 for receiving a bond wire and a second portion 22, extending substantially perpendicularly from the first portion 20, for receiving a probe tip. Similarly, the second bond pad 14 is substantially L-shaped and includes a first portion 24 for receiving a bond wire and a second portion 26, extending perpendicularly from the first portion 24, for receiving a probe tip. The first and second bond pads 12 and 14 are nested one with the other such that the second portions 22 and 26 of the first and second bond pads 12 and 14 are adjacent to each other and the first portions 20 and 24 of the first and second bond pads 12 and 14 are spaced from each other. Since the first and second bond pads 12 and 14 are L-shaped, there is an efficient usage of space.

The embedded power and ground pads 16 and 18 are adjacent to the first portion 20 of the first bond pad 12. In the embodiment shown, the embedded power pad 16 includes a first portion 28 for receiving a bond wire and a second portion 30 extending substantially perpendicularly from the first portion 28, while the embedded ground pad 18 is square shaped. In addition, the power and ground pads 16 and 18 are nested one with the other such that the embedded ground pad 18 is adjacent to the first and second portions 28 and 30 of the embedded power pad 16, as shown. Although embedded power and ground pads are provided, the first and second bond pads 12 and 14 can be used as signal pads, power pads, or ground pads. That is, despite the fact that the pair of first and second bond pads includes embedded power and ground pads, the first and second bond pads also can be used to for power and ground.

In the embodiment shown, the embedded power pad 16 is generally L-shaped and the embedded ground pad 18 is square shaped. However, the embedded power and ground pads 16, 18 both could be rectangular shaped and located side-by-side or one above the other. The embedded power and ground pads 16 and 18 are called “embedded” pads because they are nested together to form paired power and ground for optimum functionality.

As discussed above, bond pads are provided for receiving wires or probe tips. The sites for receiving bond wires are indicated as circles, while the sites for receiving probe tips are indicated with ovals. Further, bond wires may be received at various locations on the first portions 20 and 24 of the first and second bond pads 12 and 14. For example, a bond wire may be received at either a first bond location 32, a second bond location 34 or a third bond location 36 on the first portion 20 of the first bond bad 12. The bond wire may be similarly located on the first portion 24 of the second bond pad 24. This provides greater flexibility in bond wire placement and allows greater spacing between bond wires. Advantageously, the risk of wire shorting arising from wire looping and wire trajectory variations and from wire sweep during mold encapsulation can be reduced by increasing the spacing between the bond wires. The bond wires received by the first portions 20, 24 and 28 of the first bond pad 12, the second bond pad 14 and the embedded power pad 16 may be attached thereto with respective ball bonds (not shown).

In one embodiment, the first portions 20 and 24 of the first and second bond pads 12 and 14 have respective lengths L₁ of about 100 microns (μm). However, the present invention is not limited by the length L₁ of the first portions 20 and 24 of the first and second bond pads 12 and 14.

Widths W₁ of the first portions 20, 24 and 28 of respective ones of the first bond pad 12, the second bond pad 14 and the embedded power pad 16, and of the embedded ground pad 18 may be varied to accommodate various ball bond sizes. This provides greater bonding flexibility and facilitates wire bond formation with ball bonds of larger diameters. Advantageously, bonding robustness, and consequently package reliability, can be improved by the use of ball bonds with larger diameters in wire bond formation. In one embodiment, the first portions 20 and 24 of the first and second bond pads 12 and 14 have respective widths W₁ of at least about 55 μm to accommodate ball bonds received on the first portions 20 and 24 of the first and second bond pads 12 and 14 having diameters D of about 40 μm. However, it should be understood that the present invention is not limited by the width W₁ of the first portions 20 and 24 of the first and second bond pads 12 and 14 or by the diameters D of the ball bonds received.

In the present embodiment, the second portions 22 and 26 of the first and second bond pads 12 and 14 are for receiving a probe to test the functionality of the semiconductor device 10. The semiconductor device 10 may be tested in a known manner using existing equipment and conventional probe testing methods. In one embodiment, in order to accommodate industry available probe tips, the second portions 22 and 26 of the first and second bond pads 12 and 14 have respective lengths L₂ of at least about 60 μm. However, it should be understood that the present invention is not limited by the length L₂ of the second portions 22 and 26 of the first and second bond pads 12 and 14.

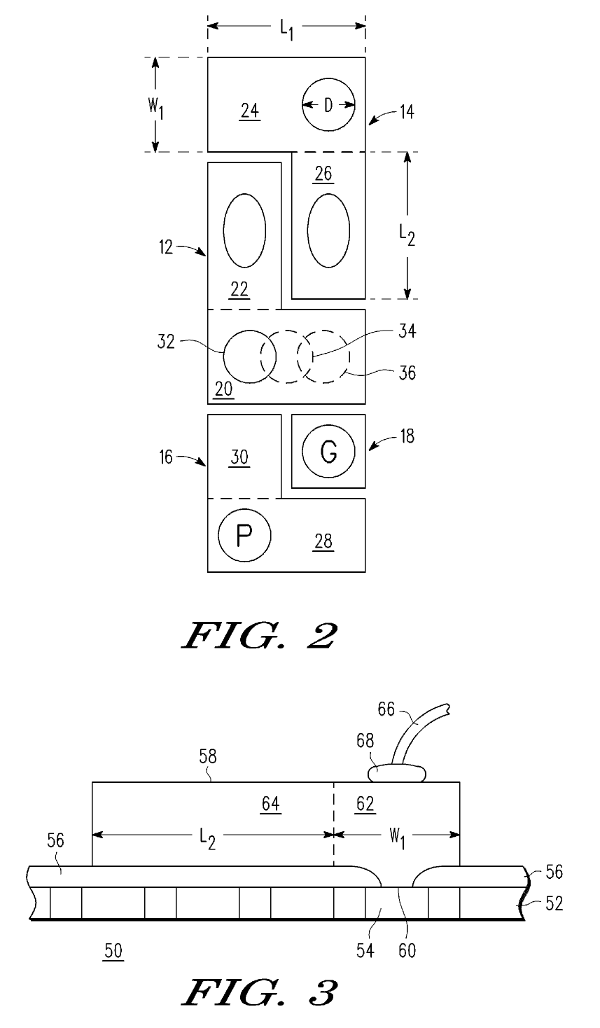

Referring now to FIG. 3, an enlarged cross-sectional view of a bond pad 50 in accordance with one embodiment of the invention is shown. The bond pad 50 is a bond over passivation (BOP) type bond pad. More particularly, the bond pad 50 includes a final metal layer 52, which as known by those of skill in the art is an etched metal layer, such as an etched copper layer, that is one of multiple copper layers, and a final layer bond pad 54. A layer of passivation material 56 is formed over the final metal layer 52, and a metal cap layer 58 is formed over a portion of the passivation layer 56. The metal cap layer 58 is formed over an opening 60 in the passivation layer 56. The opening 60 in the passivation layer 56 allows for electrical connection between the bond pad 50 and the underlying circuitry (not shown) of the semiconductor device. The passivation layer 56 is used to protect the interconnecting circuitry of the semiconductor device from moisture and contamination. The passivation layer 56 may comprise silicon dioxide or silicon nitride.

The metal cap layer 58, which in one embodiment is formed of aluminum, includes a first, wire bond portion 62 and a second, probe portion 64. The wire bond portion 62 has a width W₁ (as in FIG. 2) and the probe portion 64 has a length L₂ (as in FIG. 2). A wire 66 is shown attached to the wire bond portion 62 with a ball bond 68.

The bond pad 50 is formed in a known manner using existing equipment and processes. Accordingly, further description of the manufacture of the bond pad 50 is not required for a complete understanding of the present invention. Further, although in the present embodiment the final metal layer pad 52 is formed of copper (Cu) and the metal cap layer 58 is formed of a relatively thick layer of aluminum (Al), it should be appreciated that the present invention is not limited to Cu wafer fab applications; the pad layer 54 and the final metal layer 56, including the final metal layer pad 52, may be formed of other conductive materials in other embodiments. For example, the final metal layer pad 52 may be formed of gold (Ag) and the pad layer 54 may be formed of Cu in another embodiment.

As is evident from the foregoing discussion, the present invention provides a bond pad for a semiconductor device that provides for decreased pitch in bond placement yet allows good spacing between bond wires. Advantageously, the risk of wire shorting arising from wire looping and wire trajectory variations and from wire sweep during mold encapsulation can be reduced by increasing the spacing between the bond wires. Additionally, because the width of a bond wire receiving portion of the bond pad of the present invention can be varied to accommodate various ball bond sizes, greater bonding flexibility is provided and wire bond formation with ball bonds of larger diameters can be accommodated with the present invention. Advantageously, bonding robustness, and consequently package reliability, can be improved by the use of ball bonds with larger diameters in wire bond formation. Further, the bond pad of the present invention may be used in ultra fine pitch applications without having to increase die size.

The description of the preferred embodiments of the present invention have been presented for purposes of illustration and description, but are not intended to be exhaustive or to limit the invention to the forms disclosed. It will be appreciated by those skilled in the art that changes could be made to the embodiments described above without departing from the broad inventive concept thereof. For example, although an embodiment of the present invention is described above as being applied to Cu wafer fab technology, the present invention is not limited to Cu wafer fab technology. The present invention can also be applied to other wafer fab technologies. Additionally, the bond pad dimensions may vary to accommodate semiconductor device requirements. It is understood, therefore, that this invention is not limited to the particular embodiments disclosed, but covers modifications within the spirit and scope of the present invention as defined by the appended claims.

1. A bond pad for a semiconductor device, comprising:
a first portion for receiving a bond wire; and
a second portion, extending substantially perpendicularly from the first portion, for receiving a probe tip.

2. The bond pad of claim 1, wherein the first and second portions substantially define an L-shape.

3. The bond pad of claim 1, wherein the first portion has a width of about 50 μm.

4. The bond pad of claim 3, wherein the first portion has a length of about 100 μm.

5. The bond pad of claim 4, wherein the second portion has a length of about 60 μm.

6. The bond pad of claim 5, wherein the bond wire received by the first portion is attached thereto with a ball bond, the ball bond having a diameter of about 40 μm.

7. The bond pad of claim 1, further comprising an embedded power pad adjacent to the first portion.

8. The bond pad of claim 1, further comprising an embedded ground pad adjacent to the first portion.

9. The bond pad of claim 8, further comprising an embedded power pad adjacent to the first portion and the embedded ground pad.

10. A pair of bond pads for a semiconductor device, comprising:
a first substantially L-shaped bond pad including a first portion for receiving a bond wire and a second portion extending substantially perpendicularly from the first portion for receiving a probe; and
a second substantially L-shaped bond pad including a first portion for receiving a bond wire and a second portion extending substantially perpendicularly from the first portion for receiving a probe, wherein the first and second bond pads are nested one with the other such that the second portions of the first and second bond pads are adjacent to each other and the first portions of the first and second bond pads are spaced from each other.

11. The pair of bond pads of claim 10, further comprising:
an embedded power pad adjacent to the first portion of the first bond pad; and
an embedded ground pad adjacent to the first portion of the first bond pad.

12. The pair of bond pads of claim 11, wherein the embedded power pad includes a first portion for receiving a bond wire and a second portion extending substantially perpendicularly from the first portion, the first and second portions of the embedded power pad substantially defining an L-shape.

13. The pair of bond pads of claim 12, wherein the embedded ground pad is substantially rectangular in shape and is nested with the embedded power pad such that the embedded ground pad is adjacent to the first and second portions of the embedded power pad.

14. The pair of bond pads of claim 10, wherein the first portions of the first and second bond pads have respective widths of about 50 μm.

15. The pair of bond pads of claim 14, wherein the first portions of the first and second bond pads have respective lengths of about 100 μm.

16. The pair of bond pads of claim 15, wherein the bond wires received by the first portions of the first and second bond pads are attached thereto with respective ball bonds, the ball bonds having respective diameters of about 40 μm.

17. The pair of bond pads of claim 16, wherein the second portions of the first and second bond pads have respective lengths of about 60 μm.

18. A semiconductor device, comprising:
a plurality of first substantially L-shaped bond pads on a surface of the semiconductor device, the first bond pads having first portions for receiving respective bond wires and second portions for receiving a probe, the second portions extending substantially perpendicularly from respective ones of the first portions.

19. The semiconductor device of claim 18, further comprising:
a plurality of second substantially L-shaped bond pads having first portions for receiving respective bond wires and second portions for receiving a probe, the second portions extending substantially perpendicularly from respective ones of the first portions, wherein the first bond pads are nested with respective ones of the second bond pads such that the second portions of the first and second bond pads are adjacent to each other and the first portions of the first and second bond pads are spaced from each other.

20. The semiconductor device of claim 19, further comprising:
a plurality of embedded power pads adjacent to the first portions of respective ones of the first bond pads; and
a plurality of embedded ground pads adjacent to the first portions of respective ones of the first bond pads.
